(19) United States
(12) Patent Application Publication
(10) Pub. No.: US 2016/0034910 A1
(43) Pub. Date: Feb. 4, 2016

(54) DATA PROCESSING OF CARBON OFFSETS FOR ENTITIES

(71) Applicant: GreenPrint LLC, Atlanta, GA (US)

(72) Inventor: Peter George Davis, Atlanta, GA (US)

(21) Appl. No.: 14/815,369

(22) Filed: Jul. 31, 2015

Related U.S. Application Data
(60) Provisional application No. 62/032,232, filed on Aug. 1, 2014.

(51) Int. Cl. G06Q 30/00; G06Q 30/02; G06Q 20/02

(52) U.S. Cl. CPC G06Q 30/018; G06Q 20/02; G06Q 30/0226

(57) ABSTRACT

Disclosed are various embodiments for performing data processing to identify an entity to offset carbon credits. A geolocation of a client device performing a transaction where an item is purchased is determined. At least one entity is identified from a plurality of potential entities from a data store based at least in part on the geolocation of the client device. An amount of carbon credits required to offset an amount of greenhouse gas emissions that has been or will be produced in association with the item is determined. If the transaction is to include a purchase for the amount of carbon credits, information associated with the transaction is communicated to the entity over a network.

### CROSS-REFERENCE TO RELATED APPLICATION(S)

This application claims the benefit of and priority to co-pending U.S. Patent Application No. 62/032,232, filed on Aug. 1, 2014, entitled “PURCHASING CARBON OFFSETS AT POINT OF SALE,” which is hereby incorporated by reference in its entirety herein.

### BACKGROUND

Energy derived from fossil fuels, such as oil, coal, and gas, release carbon and other greenhouse gases (GHGs) into the atmosphere, thereby acting as a major contributor to climate change. Carbon offsetting is the process by which businesses and households compensate for the release of these GHG emissions by funding certified GHG emission reduction projects that destroy GHG emissions, prevent the release of GHGs elsewhere, and/or sequestrate existing carbon dioxide. A carbon credit, also referred to as a carbon offset, is a financial unit of measurement that represents the removal of one ton of carbon dioxide equivalent (tCO₂e) from the atmosphere.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a client device executing a client application according to various embodiments of the present disclosure.

FIG. 2 is a drawing illustrating a networked environment configured to perform a transaction where carbon credits may be purchased according to various embodiments of the present disclosure.

FIG. 3 is a drawing illustrating another embodiment of a networked environment configured to perform a transaction where carbon credits may be purchased according to various embodiments of the present disclosure.

FIG. 4 is a flowchart illustrating one example of functionality implemented as portions of the networked environment of FIGS. 2-3 according to various embodiments of the present disclosure.

FIG. 5 is a flowchart illustrating another example of functionality implemented as portions of the networked environment of FIGS. 2-3 according to various embodiments of the present disclosure.

FIG. 6 is a schematic block diagram that provides one example illustration of a computing environment according to various embodiments of the present disclosure.

### DETAILED DESCRIPTION

The present disclosure relates to data processing of carbon offsets or investing in carbon sequestering projects for entities. Carbon credits are derived from GHG emission reduction projects that deliver measurable reductions in emissions by either replacing the use of dirty fossil fuels with renewable energy, reducing the use of fossil fuels through energy efficiency, or capturing and storing already released carbon in trees and other plants. Climate change caused by GHG emissions is a serious global problem. National and international attempts to mitigate the growth in atmospheric concentrations of GHGs have resulted in the formation of a carbon market.

Currently, the carbon market comprises a compliance market, including GHG emitters who are legally obligated to reduce their emissions, and a voluntary market, including organizations voluntarily reducing their carbon emissions. In 1992 the United Nations Framework Convention on Climate Change (UNFCCC) was created to raise awareness and build knowledge to help mitigate climate change. In 1997, more than 170 countries adopted the Kyoto Protocol to the Convention, establishing legally binding targets for 37 industrialized countries to limit or reduce overall GHG emissions by at least 5% below 1990 levels during the period 2008-2012.

As opposed to regulated carbon markets (e.g., where a government entity has regulated carbon emission and created a market for the purchase and sale for carbon offsets), the voluntary markets represent business and client demand for action on climate change on a voluntary basis. While various companies have embraced sustainability and the carbon offset market, client adoption of carbon offsets has been limited because of a lack of broad knowledge of the industry and the absence of a system to efficiently distribute carbon offsets to individual clients based on their consumption. Accordingly, it is beneficial for a system to facilitate a mandatory or voluntary purchase of carbon credits based on estimated future GHG emissions caused by an exchange of goods or services at a point of sale. For example, when a consumer purchases gas at a gas station (or similar goods or services at a point of sale), the consumer may be prompted to purchase carbon credits desired or required to offset, in whole or in part, the estimated GHG emissions that was or will be generated using the gas purchased.

According to various embodiments of the present disclosure, a computing environment having one or more server computing devices may be employed to identify a geolocation of a client device performing a transaction where an item, such as fuel, is purchased. A data store having physical memory and data stored thereon may be queried to identify one or more entities or projects based at least in part on the geolocation of the client device, where the one or more entities or projects perform a service within a predefined distance of the geolocation.

An amount of carbon credits required to offset an amount of greenhouse gas emissions that will be produced in association with the manufacturing, shipping, and/or intended use of the item purchased may be determined. Further, a determination may be made to include a purchase of the amount of carbon credits in the transaction. If the purchase of the amount of carbon credits is to be included in the transaction, information associated with the transaction may be communicated to the one or more identified entities or projects over a network via an application programming interface (API) or other suitable interface.

According to further embodiments of the present disclosure, a computing device may be employed to initiate a pairing between the computing device and a client device (e.g., a smartphone, tablet, laptop, wearable computing device, computer device embedded in or in data communication with a vehicle) executing a payment application to conduct a financial transaction for carbon credits and/or for the goods or services subject to the financial transaction. The client device and/or the payment application may be associated with a user account corresponding to the user of the client device. In various embodiments, the computing device may be implemented in a fuel dispensing apparatus, such as a gas pump at a gas station. In other embodiments, the computing device may be implemented in a remote server environment. The computing device may further estimate an amount of GHG emissions that will be produced by the user using an amount of fuel produced by the fuel dispensing apparatus (e.g., information associated with the goods or services subject to the transaction) and information associated with the user account (e.g., a make, model, year of vehicle defined by the user).

The computing device may ultimately determine an amount of carbon credits required to offset the estimated amount of GHG that have been or will be produced. Further, the computing device may communicate the amount of carbon credits and the amount of GHG emissions to the client device for rendering in a display of the client device which prompts the user to determine whether to proceed with the transaction. In response to a purchase initiated by the user of the client device, the computing device may initiate performance of a financial transaction for the purchase of the carbon credits and the amount of fuel produced by the fuel dispensing apparatus.

Although the purchase may be carried out by the computing device implemented in the fuel dispensing apparatus, in alternative embodiments, the purchase is carried out by another type of device, such as a smartphone or a tablet computing device, executing a payment application over a cellular or wireless fidelity (WiFi) network.

In some embodiments, the purchase may be broken down to a first purchase for the amount of carbon credits and a second purchase for the amount of fuel produced by the fuel dispensing apparatus. According to various embodiments, the first purchase may be communicated to an application programming interface of a selling entity, such as a fuel merchant, to carry out the first purchase while the second purchase may be communicated to an application programming interface of a third-party carbon credit merchant to carry out the second purchase. In alternative embodiments, the second purchase may be communicated to an application programming interface of a local third-party charitable merchant to carry out the second purchase. As may be appreciated, the first purchase and the second purchase may be performed seamlessly on the back-end of a network such that the purchases appear as a single transaction to the user.

As may be appreciated, the embodiments described above facilitate offsetting carbon emissions for the manufacture, distribution, and/or intended use of a product. In the case of gasoline or other type of fuel, the carbon credits required to cover the pollution a customer will generate when they drive on a gallon of gasoline may be estimated based at least in part on average vehicle emissions or those specific to the make, model, and/or year of their vehicle. The GHG emissions estimated by the computing device may vary for each customer based on location, climate, type of car, type of fuel (e.g., E85, 87 octane, 89 octane, 91 octane, diesel), amount of fuel purchased, time of year (e.g., by month or by season), elevation, average or exact miles per hour driven (e.g., as specified by the user), size and age of home, and other factors depending on the product. Further, the GHG emissions may be estimated based on other variables that may affect individual emissions including weather, time of day, elevation, and others as established by the United States Energy Information Administration.

According to various embodiments, the computing device and/or the client device may be configured to allow the user to choose from a list of qualified projects offered by qualified entities and select a project and/or entity from which to purchase their carbon offsets either at the gasoline pump or through a third-party service (e.g., Paypal®, Amazon® Payments, etc.). In addition to or in place of purchasing carbon offsets, money from the transaction can be voluntarily invested in projects or programs that sequester carbon or other greenhouse gasses from the atmosphere or have some measurable environmental benefit. For example, a local non-profit may offer carbon offsets by planting trees. Accordingly, by purchasing gas at a location, proceeds from the purchase of the carbon offsets may go to a nearby charity dedicated to improving the location, for example, in an environmentally-benefitting manner, e.g., by planting trees, building a local park, reducing alternative carbon emissions, etc.

In further embodiments, a project or entity may automatically be selected based on a reward code, a type of reward card, or a type of payment card used in carrying out the transaction. For example, an entity, such as a corporate enterprise, may specify an organization to purchase carbon offsets. If a driver of a delivery truck uses a reward card offered by this organization, the entity specified by the organization may be identified to purchase suitable carbon offsets during the transaction, at the end of the transaction, or at a predefined time in the future. To this end, in some embodiments, a predefined amount of transactions performed using a reward code, reward card, or payment card may be coalesced at a later time to perform a single purchase of carbon offsets, as opposed to being performed at each transaction.

The future purchase of carbon offsets for the coalesced transactions can be performed using, for example, a web-based portal offered up by a server environment. The web-portal may be made accessibe to administrators of an organization responsible for purchasing carbon offsets. Additionally, the web-based portal may facilitate generating a report describing GHG emission habits for a user or organization as well as a history of carbon offsets purchased.

In some embodiments, a project or entity may be automatically determined by utilizing an image capturing device, such as a digital camera, to capture an image of a car license plate at the point of sale (e.g., the gasoline pump). A set of image processing algorithms may cross-reference the car license plate against a vehicle registration database, a manufacturer database, or other suitable database, to identify a project or entity from which to purchase carbon credits. As a non-limiting example, if a user has a license plate with a logo for a wetlands conservation organization, a project the same as or similar to the wetlands conservation organization may be selected for the purchase of the carbon credits. In another example, if a user has a license plate listing “Fulton County” and “Georgia,” an organization or project within Fulton County may be identified and selected for the purchase of the carbon credits.

According to various embodiments, a user may be permitted to purchase fractions of carbon dioxide offset credits (e.g., one-half credit being equal to one-half metric ton) at the point of sale or at a future time via the computing device or the client device. The fractions are referred to as micro offsets. Thus, if a car emits 0.008 metric tons of carbon dioxide per gallon, the client may purchase 0.008/1 or 0.008 certified carbon offset credits when purchasing one gallon of gas at the pump. Likewise, the client may purchase 0.016 certified carbon offset credits when purchasing two gallon of gas at the pump, etc. According to various embodiments, carbon dioxide offsets may bundled into the price of the product (e.g., gasoline) at the point of sale (e.g., the gas pump) and may be paid for by a manufacturer, refiner, and/or gas station as opposed to the user. In alternative embodiments, the carbon dioxide offsets may be paid for by the user.

According to various embodiments, an opt-in option (allowing customers to opt-in to choose to offset their carbon) may be available at the point of sale which may allow a user to add information associated with their particular car (e.g., make, model, year) or average carbon dioxide emissions. Further, the user may select which projects to offset the emissions when they purchase the product (e.g., gasoline). In some embodiments, loyalty reward cards, reward code, and/or payment cards used in a transaction may be recognized to provide the user with a financial discount during or after the purchase. For example, employers may offer employees a ten cents (or other amount) reduction on price per gallon of fuel if the user pays with a reward card or a reward code made available by the employers. To this end, the employer may acquire consumption habits of their employees based on reward card or code usage and may desire to purchase carbon offsets to offset GHG emissions produced by the employees.

In various embodiments, the points or financial incentives offered by a particular brand of credit card may be used to purchase the carbon credits. For example, assuming a particular type of credit card offers the owner of the credit card 3% back on all gas purchases (e.g., in the form of points or rebates), the owner may decide to apply the 3% to purchase all or a portion of the carbon credits required to offset the GHG emissions. Further, in some embodiments, the computing device allows the user to make micro-donations or contributions to one or multiple green projects which may or may not be certified carbon offset projects, but nevertheless relate to and/or benefit the environment.

In the following discussion, a general description of the system and its components is provided, followed by a discussion of the operation of the same.

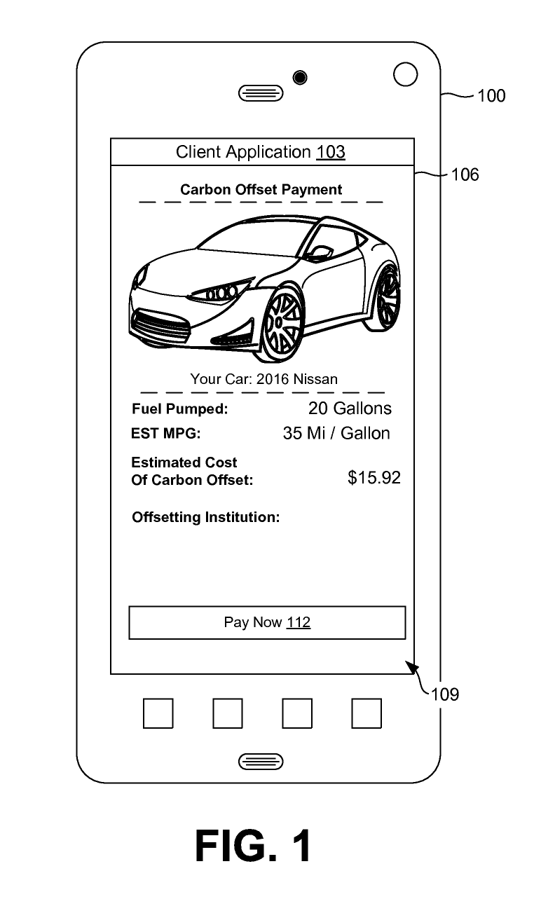

With reference to FIG. 1, shown is a non-limiting example of a client device 100 executing a client application 103 to facilitate a purchase of carbon offsets at a point of sale where an item is purchased. Although the present disclosure provides an example point of sale as a purchase of gas at a gas station, the invention is not so limited. For example, the purchase of carbon offsets may be employed at sporting events, charitable auctions, restaurants, grocery stores, etc. Further, in some embodiments, the purchase of carbon offsets may be performed after an item has been purchased at a different location.

The client application 103 may be described as a payment application, where the user of the client device 100 initiates a purchase for one or more carbon offsets and/or goods or services subject to the transaction via the client application 103. A financial transaction for the purchase may be conducted by the client device 100 over a cellular network or other similar network (e.g., WiFi, Bluetooth, Zygbee), or may be communicated to a computing device to conduct the financial transaction.

In the example of FIG. 1, a display 106 of the client device 100 may render one or more user interfaces 109 for the client application 103. To this end, the user may navigate the one or more user interfaces 109 to provide information associated with the user and/or information pertaining to the future use of the good or service subject to the transaction. Such information may comprise, for example, the make, model, and year of the vehicle driven by the user. If the user purchases fuel at a gas station, a computing device may communicate the fuel pumped by the user for display in the client application 103. In addition, an estimated cost for purchasing the carbon offset may be communicated to the client device 100 for display in the client application 103.

In various embodiments, the client device 100 may determine the estimated cost for purchasing the carbon offset. The user may initiate the payment by engaging the “pay now” component 112, which, as may be appreciated, may conduct the financial transactions using previously stored payment data (e.g., identification and/or credit card information, etc.). According to various embodiments, additional components may be rendered in the user interface 109 to facilitate the sharing of information of the transaction via various social media outlets such as Facebook®, Twitter®, and Instagram®, etc., either automatically or upon request or selection by the user. Similarly, additional components may be rendered in the user interface 109 to facilitate the sharing of information of the transaction via email, instant messaging, or SMS.

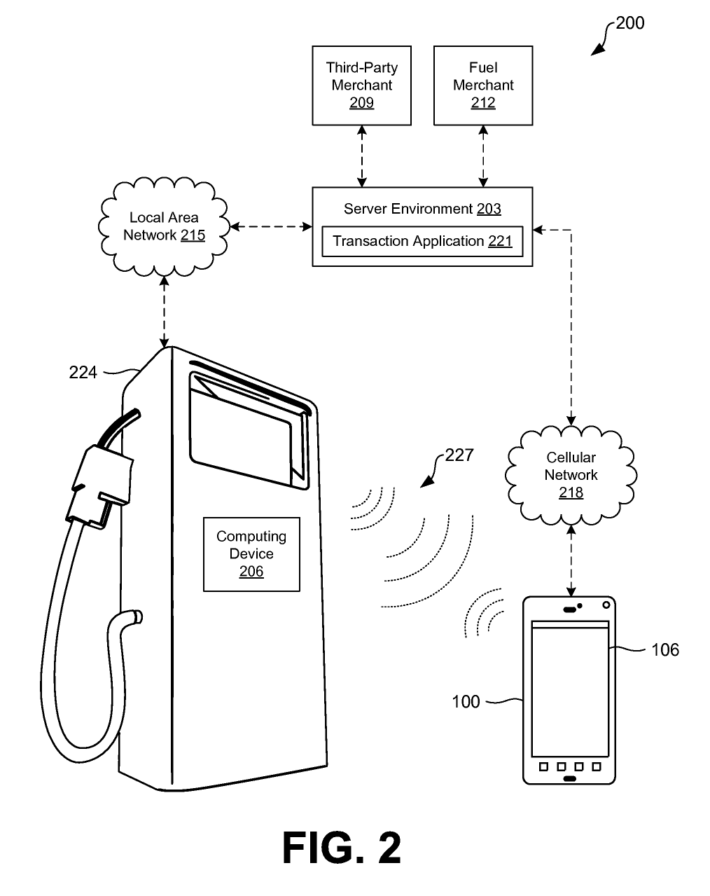

Moving on to FIG. 2, shown is a networked environment 200 according to various embodiments. The networked environment 200 includes a server environment 203, a computing device 206, the client device 100, a third-party merchant 209, and a fuel merchant 212, which are in data communication with each other via one or more networks, such as a local area network (LAN) 215 and/or a cellular network 218. The one or more networks may further comprise, for example, the Internet, intranets, extranets, wide area networks (WANs), wired networks, wireless networks, or other suitable networks, etc., or any combination of two or more such networks. For example, such networks may comprise satellite networks, cable networks, Ethernet networks, and other types of networks.

The server environment 203 may comprise, for example, a server computer or any other system providing computing capability. Alternatively, the server environment 203 may employ a plurality of computing devices that may be arranged, for example, in one or more server banks or computer banks or other arrangements. Such computing devices may be located in a single installation or may be distributed among many different geographical locations. For example, the server environment 203 may include a plurality of computing devices that together may comprise a hosted computing resource, a grid computing resource and/or any other distributed computing arrangement. In some cases, the server environment 203 may correspond to an elastic computing resource where the allotted capacity of processing, network, storage, or other computing-related resources may vary over time.

Various applications and/or other functionalities may be executed in the server environment 203 according to various embodiments. Also, various data is stored in a data store that is accessible to the server environment 203. The components executed on the server environment 203, for example, include a transaction application 221 executed to conduct financial transactions using data provided by the computing device 206 located at the point of sale, and other applications, services, processes, systems, engines, or functionality not discussed in detail herein.

The client device 100 is representative of a plurality of client devices that may be coupled to the cellular network 215. The client device 100 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, computing devices embedded in or is data communication with a vehicle, or other devices with like capability. The client device 100 may include the display 106 comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 100 may be configured to execute various applications such as the client application 103 and/or other applications. The client application 103 may be executed in a client device 100, for example, to access network content served up by the server environment 203 and/or other servers, thereby rendering a user interface on the display 106. To this end, the client application 103 may comprise, for example, a browser, a dedicated application, etc. The user interface 109 (FIG. 1) may comprise a network page, an application screen, etc. The client device 100 may be configured to execute applications beyond the client application 103 such as, for example, email applications, social networking applications, word processors, spreadsheets, and/or other applications.

Next, a general description of the operation of the various components of the networked environment 200 is provided. To begin, it is assumed that a customer (e.g., the user of the client device 100) is purchasing a product or service at the point of sale. For example, the user may be purchasing fuel via a fuel dispensing apparatus 224 at a gas station. The computing device 206 may be implemented within the fuel dispensing apparatus 224 and be capable of measuring the amount of fuel dispensed by the fuel dispensing apparatus 224.

According to various embodiments, the computing device 206 located at a point of sale may facilitate the purchase of carbon offsets. For example, a display of a computing device 206 implemented within the fuel dispensing apparatus 224 may provide one or more user interfaces for the user to select carbon offsets to purchase. In other embodiments, the server environment 203, located remotely, may facilitate the purchase of carbon offsets. For example, the server environment 203 may determine whether to perform purchases of carbon credits without requiring input from a user. Further, in some embodiments, the client device 100 may facilitate the purchase of carbon offsets by allowing the user to provide information associated with their GHG emissions on their client device 100.

A geolocation of a transaction, or a device performing the transaction, may be determined where an item, such as fuel, is purchased. For example, the computing device 206 may be implemented in the fuel dispensing apparatus 224 to carry out a transaction where a person buys fuel. The geolocation of the computing device 206 may be determined, for example, by querying a database of known fuel dispensing apparatuses 224 using a unique identifier for the fuel dispensing apparatus 224. In embodiments where the client device 100 is performing the transaction, the client device 100 may communicate geolocation data obtained using a location module (e.g., GPS or WiFi) of the client device 100.

Next, a database may be queried to identify one or more entities from which carbon offsets may be purchased (or carbon may be sequestered) based at least in part on the geolocation of the client device. In various embodiments, the one or more entities may perform a service within a predefined distance of the geolocation. For example, a local non-profit organization may offer carbon offsets. Accordingly, by purchasing gas at a location, proceeds from the purchase of the carbon offsets may go to a local charity dedicated to improving the location, for example, in an environmentally-benefitting manner, e.g., by planting trees, building a local park, reducing alternative carbon emissions, etc.

The one or more entities may be rendered on a display 106 of the client device 100 or on a display of the computing device 206. A user interface rendered on the display 106 may include the one or more entities and may facilitate the selection of at least one of the one or more entities from which to purchase carbon offsets. In some embodiments, the user interface may facilitate dividing the purchase of carbon offsets among multiple entities. If the user provides a selection of one or more entities, the one or more entities selected may be used to purchase carbon offsets.

In other embodiments, a project or entity may be automatically determined as opposed to being provided to a user for selection. For example, a project or entity may be determined based on a reward code, a type of reward card, or a type of payment card used in performing the transaction. In one example, an entity, such as a corporate enterprise, may specify a particular organization from which the corporate enterprise desires to purchase carbon offsets. If a driver of a delivery truck uses a reward card offered by the corporate enterprise, the entity specified by the enterprise may be identified to purchase suitable carbon offsets during the transaction, at the end of the transaction, or at a predefined time in the future. To this end, in some embodiments, a predefined amount of transactions performed using a reward code, reward card, or payment card may be coalesced to perform a single purchase of carbon offsets, as opposed to being performed during each transaction.

In some embodiments, other factors may be used for an organization to perform a “wholesale” calculation of the GHG emissions emitted by the organization. Such factors may include, for example, a number and type of vehicles in the organization's fleet, average miles drives by each vehicle, type of fuel used for each vehicle, average miles per gallon for each vehicle, other factors such as the average weather over a period of time, an average time of day the vehicles are driven, an average elevation, and other factors as established by the United States Energy Information Administration.

An amount of carbon credits required to offset an amount of greenhouse gas emissions that will be produced in association with the manufacturing, shipping, and/or intended use of the item purchased may be determined. In some embodiments, the GHG emissions may be estimated based on a location, climate, type of car, altitude, temperature, the average or exact miles per hour driven, size and age of home, and other factors that may vary depending on a type of the product being purchased.

Further, a determination may be made whether to include a purchase of the amount of carbon credits determined. For example, the user may be prompted on a display 106 to indicate whether the user desires to include a purchase of the carbon offsets in the transaction. If the purchase of the amount of carbon credits is to be included in the transaction, information associated with the transaction may be communicated to the one or more identified entities over a network via an application programming interface (API) or other suitable interface.

In some embodiments, the server environment 203 may generate a ranking of the user with respect to his or her geographic area based on the amount of carbon offsets the user has purchased relative to the amount of GHG emissions likely produced by the user. For example, a user may be notified if he or she is the “greenest” compact car driver in the Atlanta-metro region. Accordingly, in various embodiments, the server environment 203 may generate a ranking of users for regions (e.g., cities, states, zip codes, countries) based on GHG emissions produced, carbon offsets purchased, consumption habits, and other factors. Similarly, in some embodiments, the server environment 203 may generate a ranking of businesses using the same factors.

In further embodiments, a pairing between the computing device 206 and the client device 100 executing the client application 103 may be initiated, where the client application 103 is associated with a user account managed by the user of the client device. A pairing may comprise enabling communication between the computing device 206 and the client device 100. To this end, the pairing may be accomplished via Bluetooth®, Zygbee®, Infrared, and/or any other near field communication technology for wireless communication 227 and/or may be accomplished via the one or more networks (e.g., the cellular network 218 and the local area network 215). The computing device 206 may estimate an amount of GHG emissions that were or may be produced utilizing the amount of fuel produced by the fuel dispensing apparatus 224 and information associated with the user account. For example, the information associated with the user account may comprise a make, a model, or a year of a vehicle associated with the user account. Alternatively, the server environment 203 may estimate the amount of GHG emissions and communicate the estimated GHG emission to the computing device 206.

According to various embodiments, the fuel dispensing apparatus 224 comprises a camera configured to capture an image of a car. The computing device 206, utilizing the image of the car, may cross reference the image against a vehicle registration, manufacturer, or other database to obtain the make, model, and/or year of the car.

An amount of carbon credits required to offset the estimated amount of GHG emissions that will be produced may be estimated by the computing device 206 and/or the server environment 203. The amount of carbon credits and the amount of GHG emissions may be communicated to the client device 100 for rendering in the display 106. A purchase of the amount of carbon credits and the amount of fuel produced by the fuel dispensing apparatus 224 may be initiated by the user via the client device 100. The purchase may be carried out by communicating information associated with the financial transaction to the server environment 203 via the computing device 206 implemented in the fuel dispensing apparatus 224 or by the client device 100 executing the client application 103.

Further, the purchase may be described as a first purchase for the amount of carbon credits and a second purchase for an amount of fuel produced by the fuel dispensing apparatus 224. According to various embodiments, the first purchase is communicated to an application programming interface (API) of the fuel merchant 212 to carry out the first purchase, wherein the second purchase is communicated to the API of a third-party merchant 209 capable of providing carbon credits to carry out the second purchase. In further embodiments, the second purchase may be communicated to the API of a local third-party charitable merchant to carry out the second purchase.

In further embodiments, the computing device 206 may communicate with a user via a display (e.g., a touch screen display) embedded within and/or in data communication with the fuel dispensing apparatus 224. Accordingly, the client device 100 may be optional in this embodiment. The computing device 206 estimates an amount of greenhouse gas emissions that will be produced utilizing an amount of fuel produced by the fuel dispensing apparatus (e.g., the fuel purchased by the consumer) as well as other factors described herein. The computing device 206 then determines an amount of carbon credits required to offset the amount of greenhouse gas emissions that will be produced. The amount of carbon credits and the amount of greenhouse gas emissions are communicated to the display embedded within and/or in data communication with the fuel dispensing apparatus 224. The computing device 206 may receive user input to initiate a purchase of the amount of carbon credits and the amount of fuel produced by the fuel dispensing apparatus.

While at the pump, the user may “opt-in” to purchase carbon credits at the fuel dispending apparatus 224. For example, after pumping gas, the display within and/or in data communication with the fuel dispensing apparatus 224 may ask if the user wishes to purchase the carbon credits required to offset the GHG emissions. In various embodiments, the purchase of the carbon credit may be performed on the back-end without requiring a user to acknowledge the purchase of the carbon credits. Initiation of a back-end purchase of carbon credits may be accomplished by opting-in via a certain type of credit card previously registered to purchase carbon offsets, loyalty cards, etc.

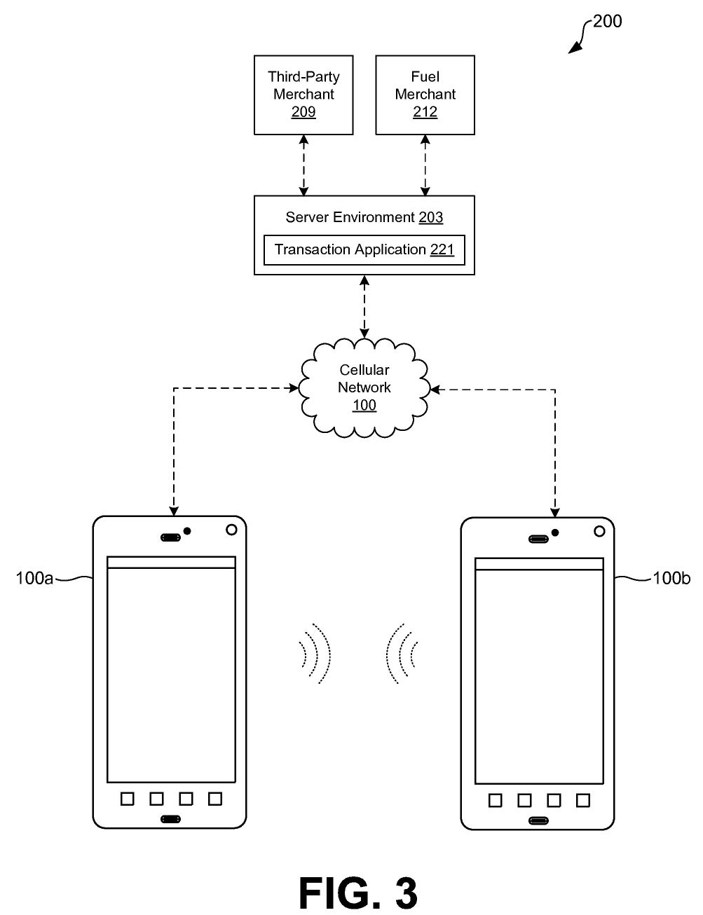

Turning now to FIG. 3, shown is another embodiment of the networked environment 200. In the non-limiting example of FIG. 3, a point of sale transaction may be conducted via a first client device 100a and a second client device 100b (collectively client devices 100). To this end, users of the client devices 100 may conduct a peer-to-peer point of sale transaction via the client devices 100. For example, a user of the first client device 100a may charge the user of the second client device 100b for a good or a service, or may share information regarding the transaction with a second client device 100b.

Information associated with the transaction may be provided by the users to the server environment 203 to estimate an amount of carbon credits required to offset GHG emissions that will be produced as a result of the transaction. The estimated of the GHG emissions may be determined using any information provided by the user such as the product or service subject to the transaction, the packaging (if applicable), and/or whether a delivery is required. The amount of carbon credits and the amount of GHG emissions may be communicated to the client devices 100 for rendering. A purchase of the amount of carbon credits and the amount of fuel produced by the fuel dispensing apparatus 224 may be initiated by the first or second user via the first client device 100a or the second client device 100b.

The purchase may be carried out by communicating information associated with the financial transaction to the server environment 203. As discussed above, the purchase may be described as a first purchase for the amount of carbon credits and a second purchase for the good or service subject to the transaction. According to various embodiments, the first purchase is communicated to an API capable of sending money to the seller, wherein the second purchase is communicated to an API of a third-party merchant 209 capable of providing carbon credits. In further embodiments, the second purchase may be communicated to an application programming interface of a local third-party charitable merchant to carry out the second purchase.

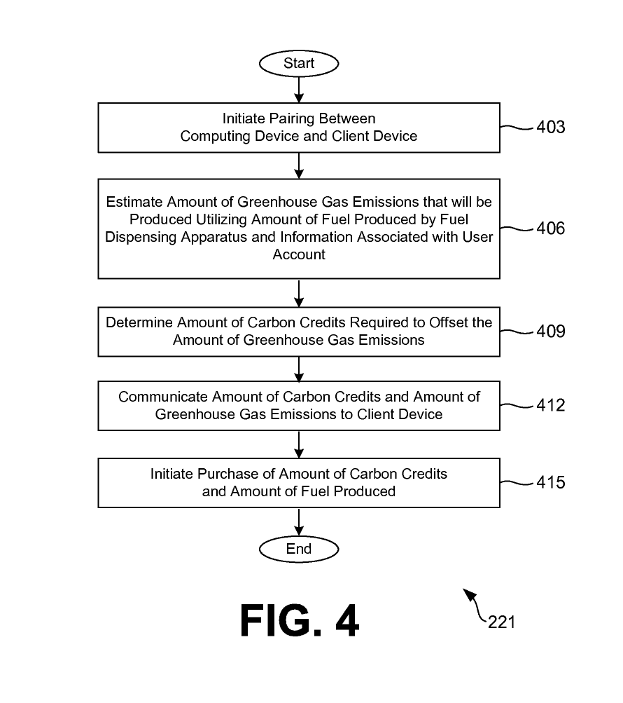

Referring next to FIG. 4, shown is a flowchart that provides one example of the operation of a portion of a point of sale transaction according to various embodiments. It is understood that the flowchart of FIG. 4 provides merely an example of the many different types of functional arrangements that may be employed to implement the operation of the portion of the embodiments described herein. As an alternative, the flowchart of FIG. 4 may be viewed as depicting an example of elements of a method implemented in the networked environment 200 (FIG. 2) according to one or more embodiments.

Beginning with 403, a pairing between a computing device 206 and the client device 100 executing a payment application (i.e., the client application 103 of FIG. 1) is initiated at a point of sale, wherein the payment application is associated with a user account associated with the user of the client device 100. In 406, an amount of GHG emissions that will be produced utilizing an amount of fuel produced by the fuel dispensing apparatus 224 and information associated with the user account is estimated. The information may comprise, for example, a make, a model, or a year of a vehicle associated with the user account. In this example, projected carbon emissions may be determined based on the average vehicle emissions produced by a vehicle with the same or similar mark, model, and/or year.

In various embodiments, estimating the amount of GHG emissions that will be produced comprises employing a seasonal reformulated gas algorithm (summer fuel versus winter fuel). Similarly, in various embodiments, a type of the fuel purchased may be used in estimating the amount of GHG emissions that will be produced (e.g., E85, E10, Diesel, and Clean Natural Gas). Although described herein as “fuel,” the same estimation may be used in the form of electrical power for electric vehicles. For example, an amount of GHG emissions produced by providing the electrical power to fully or partially charge an electric vehicle may be estimated in 406.

Moving on to 409, an amount of carbon credits required to offset the amount of greenhouse gas emissions that will be produced is estimated or determined. In 412, the amount of carbon credits and the amount of GHG emissions are communicated to the client device for rendering in a display of the client device. In 415, a purchase of the amount of carbon credits and the amount of fuel produced by the fuel dispensing apparatus 224 is initiated.

The purchase may be carried out by the computing device 206 implemented in the fuel dispensing apparatus 224 or the client device 100 executing the client application 103 by communicating purchase data to the server environment 203. Purchase data may comprise, for example, the total amount of carbon credits purchased, a description of the goods or services purchased, the amount paid, the date purchased, the location of the purchase, the intended use for the item purchased, and other demographic or purchase specific data such as the make, model, and year of a car.

Further, the purchase may be described as a first purchase for the amount of carbon credits and a second purchase for an amount of fuel produced by the fuel dispensing apparatus 224. According to various embodiments, the first purchase is communicated to an application programming interface of the fuel merchant to carry out the first purchase, wherein the second purchase is communicated to an application programming interface of a third-party carbon credit merchant to carry out the second purchase. In further embodiments, the second purchase may be communicated to an application programming interface of a local third-party charitable merchant to carry out the second purchase.

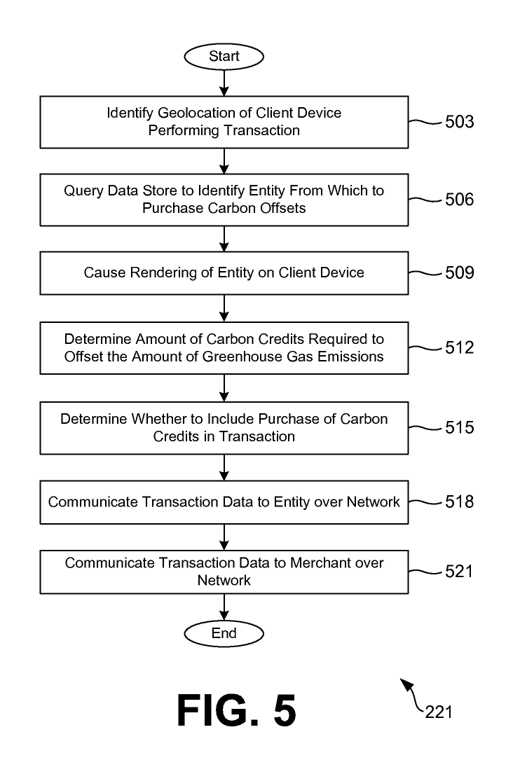

Referring next to FIG. 5, shown is a flowchart that provides one example of the operation of a portion of a point of sale transaction according to various embodiments. It is understood that the flowchart of FIG. 5 provides merely an example of the many different types of functional arrangements that may be employed to implement the operation of the portion of the embodiments described herein. As an alternative, the flowchart of FIG. 5 may be viewed as depicting an example of elements of a method implemented in the networked environment 200 (FIG. 2) according to one or more embodiments.

According to various embodiments of the present disclosure, a computing device 206 located at a point of sale may execute the transaction application 221 to perform the flowchart of FIG. 5. In other embodiments, the server environment 203, located remotely, may execute the transaction application 221 to perform the flowchart of FIG. 5.

Starting with 503, a geolocation is determined for a client device 100 or a computing device 206 that is performing a transaction where an item, such as fuel, is purchased. For example, in some embodiments, a computing device 206 may be implemented in a fuel dispensing apparatus 224 to carry out a transaction where a person buys fuel. The geolocation of the computing device 206 may be determined, for example, by querying a database of known fuel dispensing apparatuses 224 using a unique identifier for the fuel dispensing apparatus 224. In embodiments where the client device 100 is performing the transaction, the client device 100 may communicate geolocation data obtained using a location module (e.g., GPS or WiFi) of the client device 100.

Next, in 506, a database may be queried to identify one or more entities from which carbon offsets may be purchased based at least in part on the geolocation of the client device. In various embodiments, the one or more entities may perform a service within a predefined distance of the geolocation. For example, a local non-profit may offer carbon offsets. Accordingly, by purchasing gas at a location, proceeds from the purchase of the carbon offsets may go to a local charity dedicated to improving the location, for example, in an environmentally-benefitting manner, e.g., by planting trees, building a local park, reducing alternative carbon emissions, etc.

In 509, the one or more entities may be rendered on a display 106 of the client device 100 or on the computing device 206, where applicable. A user interface rendered on the display may include the one or more entities and may facilitate the selection of at least one of the one or more entities from which to purchase carbon offsets. In some embodiments, the user interface may facilitate dividing the purchase of carbon offsets among multiple entities. If the user provides a selection of one or more entities, the one or more entities selected may be used to purchase carbon offsets, as will be discussed.

In other embodiments, a project or entity may automatically be determined as opposed to being provided to a user for selection. For example, a project or entity may be determined based on a reward code, a type of reward card, or a type of payment card used in performing the transaction. For example, an entity, such as a corporate enterprise, may specify a particular organization from which the corporate enterprise desires to purchase carbon offsets. If a driver of a delivery truck uses a reward card offered by the corporate enterprise, the entity specified by the enterprise may be identified to purchase suitable carbon offsets during the transaction, at the end of the transaction, or at a predefined time in the future. To this end, in some embodiments, a predefined amount of transactions performed using a reward code, reward card, or payment card may be coalesced to perform a single purchase of carbon offsets, as opposed to being performed during each transaction.

In some embodiments, other factors may be used for an organization to perform a “wholesale” calculation of the GHG emissions emitted by the organization. Such factors may include, for example, a number and type of vehicles in the organization's fleet, average miles drives by each vehicle, type of fuel used for each vehicle, average miles per gallon for each vehicle, and other factors such as the average weather over a period of time, an average time of day the vehicles are driven, an average elevation, and other factors as established by the United States Energy Information Administration.

Accordingly, a designation made by a user, organization, or other entity in association with the reward card may be determined to perform an automated purchase of the carbon credits. The designated entity will be used to purchase the carbon offsets, as may be appreciated.

Next, in 512, an amount of carbon credits required to offset an amount of greenhouse gas emissions that will be produced in association with the manufacturing, shipping, and/or intended use of the item purchased may be determined. In some embodiments, the GHG emissions may be estimated based on a location, climate, type of car, altitude, temperature, the average or exact miles per hour driven, size and age of home, and other factors that may vary depending on a type of the product being purchased.

Further, in 515, a determination may be made whether to include a purchase of the amount of carbon credits determined in 512 in the transaction. For example, the user may be prompted to indicate whether the user desires to include a purchase of the carbon offsets in the transaction. If the purchase of the amount of carbon credits is to be included in the transaction, information associated with the transaction may be communicated to the one or more identified entities over a network via an application programming interface (API) or other suitable interface, as shown in 518 and 521.

In some embodiments, the user of the client device 100 may be provided with a ranking of the user with respect to his or her geographic area based on the amount of carbon offsets the user has purchased relative to the amount of GHG emissions likely produced by the user. For example, a user may be notified if he or she is the “greenest” compact car driver in the Atlanta-metro region. Accordingly, in various embodiments, the server environment 203 may generate a ranking of users for regions (e.g., cities, states, zip codes, countries) based on GHG emissions produced, carbon offsets purchased, consumption habits, and other factors. Similarly, in some embodiments, the server environment 203 may generate a ranking of businesses using the same factors.

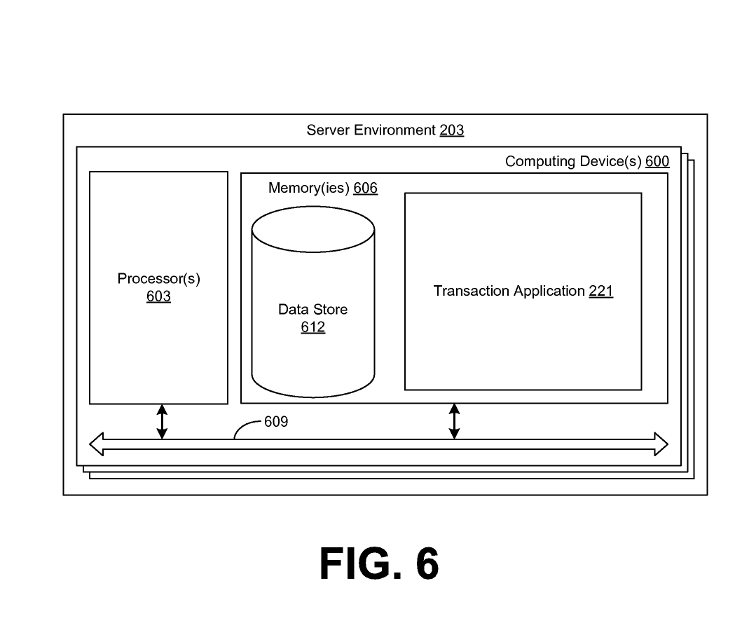

With reference to FIG. 6, shown is a schematic block diagram of a server environment 203 according to an embodiment of the present disclosure. The server environment 203 includes one or more computing devices 600. Each computing device 600 includes at least one processor circuit, for example, having a processor 603 and a memory 606, both of which are coupled to a local interface 609. To this end, each computing device 600 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the transaction application 221, and potentially other applications. Also stored in the memory 606 may be a data store 612 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and/or multiple processor cores and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Although the transaction application 221, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of a transaction application 221. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the transaction application 221, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the transaction application 221, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices in the same server environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, the program comprising instructions that, when executed, cause the computing device to:
identify a geolocation of a client device performing a transaction where a quantity of fuel is purchased, the client device being in data communication with the computing device over a network;
identify at least one entity from a plurality of potential entities from a data store based at least in part on the geolocation of the client device, wherein the entity performs a service within a predefined distance of the geolocation;
determine an amount of carbon credits required to offset an amount of greenhouse gas emissions that will be produced in association with the quantity of fuel purchased;
determine whether to include a purchase of the amount of carbon credits in the transaction; and
in response to a determination that the purchase of the amount of carbon credits is to be included in the transaction, communicate information associated with the transaction to an application programming interface of the entity over the network.

2. The non-transitory computer-readable medium of claim 1, wherein determining whether to include the purchase of the amount of carbon credits in the transaction further comprises:
causing a rendering of a subset of the plurality of potential entities in a display of the client device; and
receiving a selection of the entity as user input from the client device.

3. The non-transitory computer-readable medium of claim 1, wherein determining whether to include the purchase of the amount of carbon credits in the transaction further comprises:
identifying a type of a reward card to be used for a payment performed in the transaction from the data store;
identifying whether a designation has been made in association with the reward card to perform an automated purchase of the carbon credits; and
identifying the entity from the plurality of potential entities based at least in part on the designation.

4. The non-transitory computer-readable medium of claim 1, wherein the program further comprises instructions that, when executed, cause the computing device to perform a pairing of the computing device and the client device, wherein the client device is executing a payment application, the payment application having information associated with a user account.

5. The non-transitory computer-readable medium of claim 4, wherein the information associated with the user account is used in determining the amount of carbon credits, the information further comprising a make, a model, or a year of a vehicle associated with the user account.

6. The non-transitory computer-readable medium of claim 1, wherein the computing device is in data communication with a fuel dispensing apparatus to determine the quantity of the fuel.

7. The non-transitory computer-readable medium of claim 1, wherein the transaction comprises a first purchase for the amount of carbon credits to be made to the entity and a second purchase for the quantity of fuel produced by the fuel dispensing apparatus to be made to a fuel merchant.

8. A system, comprising:
at least one computing device; and
an application executed in the computing device, the application comprising logic that causes the computing device to:
identify a geolocation of a client device performing a transaction where an item is purchased, the client device being in data communication with the computing device over a network;
identify at least one entity from a plurality of potential entities from a data store based at least in part on the geolocation of the client device;
determine an amount of carbon credits required to offset an amount of greenhouse gas emissions that has been or will be produced in association with the item;
determine whether to include a purchase of the amount of carbon credits in the transaction; and
in response to a determination that the purchase of the amount of carbon credits is to be included in the transaction, communicate information associated with the transaction to the entity over the network.

9. The system of claim 8, wherein the entity performs a service within a predefined distance of the geolocation.

10. The system of claim 8, wherein determining whether to include the purchase of the amount of carbon credits in the transaction further comprises:
causing a rendering of a subset of the plurality of potential entities in a display of the client device prior to performance of the transaction, during performance of the transaction, or after performance of the transaction; and
receiving a selection of the entity as user input from the client device.

11. The system of claim 8, wherein determining whether to include the purchase of the amount of carbon credits in the transaction further comprises:
identifying a type of a reward card or a reward code to be used for a payment performed in the transaction from the data store;
identifying whether a designation has been made in association with the reward card or the reward code to perform an automated purchase of the carbon credits; and
identifying the entity from the plurality of potential entities based at least in part on the designation.

12. The system of claim 8, wherein the application further comprises logic that causes the computing device to perform a pairing of the computing device and the client device, wherein the client device is executing a payment application, the payment application having information associated with a user account.

13. The system of claim 12, wherein the information associated with the user account is used in determining the amount of carbon credits, the information further comprising a make, a model, or a year of a vehicle associated with the user account.

14. The system of claim 8, wherein:
the item being purchased in the transaction comprises a quantity of fuel; and
the computing device is in data communication with a fuel dispensing apparatus to determine the quantity of the fuel.

15. The system of claim 14, wherein the transaction comprises a first purchase for the amount of carbon credits to be made to the entity and a second purchase for the quantity of fuel produced by the fuel dispensing apparatus to be made to a fuel merchant.

16. A computer-implemented method, comprising:
identifying, by at least one computing device, a geolocation of a client device performing a transaction where an item is purchased, the client device being in data communication with the computing device over a network;
querying, by the computing device, a data store to identify at least one entity from a plurality of potential entities based at least in part on the geolocation of the client device;
determining, by the computing device, an amount of carbon credits required to offset an amount of greenhouse gas emissions that has been or will be produced in association with the item;
determining, by the computing device, whether to include a purchase of the amount of carbon credits in the transaction; and
in response to a determination that the purchase of the amount of carbon credits is to be included in the transaction, communicating, by the computing device, information associated with the transaction to the entity over the network.

17. The computer-implemented method of claim 16, wherein the entity performs a service within a predefined distance of the geolocation.

18. The computer-implemented method of claim 16, wherein determining whether to include the purchase of the amount of carbon credits in the transaction further comprises:
causing a rendering of a subset of the plurality of potential entities in a display of the client device; and
receiving a selection of the entity as user input from the client device.

19. The computer-implemented method of claim 16, wherein determining whether to include the purchase of the amount of carbon credits in the transaction further comprises:
identifying a type of a reward card to be used for a payment performed in the transaction from the data store;
identifying whether a designation has been made in association with the reward card to perform an automated purchase of the carbon credits; and
identifying the entity from the plurality of potential entities based at least in part on the designation.

20. The computer-implemented method of claim 16, further comprising causing, by the computing device, a pairing of the computing device and the client device, wherein:
the client device is executing a payment application, the payment application having information associated with a user account; and
the information associated with the user account is used in determining the amount of carbon credits, the information further comprising a make, a model, or a year of a vehicle associated with the user account.
